(19) United States
(12) Patent Application Publication
(10) Pub. No.: US 2019/0028797 A1
(43) Pub. Date: Jan. 24, 2019

(54) HIGH-FIDELITY AUDIO DEVICE

(71) Applicant: MERRY ELECTRONICS (SHENZHEN) CO., LTD, SHENZHEN (CN)

(72) Inventor: Po-Chang LIN, Taichung (TW)

(21) Appl. No.: 15/849,248

(22) Filed: Dec. 20, 2017

(30) Foreign Application Priority Data
Jul. 20, 2017 (TW) 106124243

(51) Int. Cl. H04R 1/10; H04R 1/32; G10K 11/178

(52) U.S. Cl. CPC H04R 1/1083; H04R 1/326; G10K 2210/1081; H04R 1/1008; H04R 1/105; G10K 11/178

(57) ABSTRACT

A high-fidelity audio device including a main microphone, a voice microphone and a process circuit. The main microphone receives sound and generates a main signal; the voice microphone perceives user's vocal vibration and produces a vocal signal; the process circuit collects the main signal and the vocal signal, superimposes and then decays the collected signals to generate a high-fidelity signal for high-definition broadcast realization.

### BACKGROUND OF THE INVENTION

### Field of the Invention

This invention relates to an audio device, and more specifically to an audio device ensuring acoustic fidelity.

### Description of the Related Art

The acoustic device is an electronic apparatus which normally translates sound into electronic signal to broadcast, usually adopts a microphone to collect sound accompanied with unavoidable ambient noise at the same time. In order to reduce or eliminate the ambient noise, the present technology ordinarily applies Active Noise Cancellation (ANC) as a technique on the basis of wave formulating theory managing to generate an noise-compensated wave which is similar to the target ambient noise in waveform, amplitude and phase difference of 180°.

However, it's difficult for ANC to precisely executing the noise-compensated process without obviously reducing the fidelity of collected sound after repeatedly reproduced, so as fail to realize high-definition audio. Besides, the requirement of Digital Signal Process (DSP) for noise-compensated process may also raise the hardware cost of microphone.

### SUMMARY OF THE INVENTION

In viewing that, the main goal of this invention is to provide a high-fidelity audio device.

To achieve above purpose accordance with other intentions, this invention provides an audio device including a main microphone, a voice microphone and a process circuit. The main microphone receives sound and generates a main signal; the voice microphone perceives user's vocal vibration and produces a vocal signal; the process circuit collects the main signal and the vocal signal, superimposes and then decays the collected signals to a high-fidelity signal.

By way of above-mentioned design, this invention of audio device can stand out user's vocal characteristics, regain brilliantly high-fidelity signal, and realize high-definition broadcast without complicated digital process.

### BRIEF DESCRIPTION OF THE DRAWINGS

FIG. 1 illustrates the first embodiment of this invention;

FIG. 2 illustrates a block diagram according to the first embodiment of this invention;

FIG. 3 illustrates a spectrum chart of the main signal according to the first embodiment of the invention;

FIG. 4 illustrates a spectrum chart of the vocal signal according to the first embodiment of the invention;

FIG. 5 illustrates a spectrum chart of the main signal superimposed on the vocal signal according to the first embodiment of the invention;

FIG. 6 illustrates a spectrum chart of the high-fidelity signal according to the first embodiment of the invention;

FIG. 7 illustrates a block diagram according to the second embodiment of the invention;

FIG. 8 illustrates a flow chart according to the second embodiment of the invention;

FIG. 9 illustrates a spectrum chart of the main signal according to the second embodiment of this invention;

FIG. 10 illustrates a spectrum chart of the vocal signal according to second embodiment of the invention;

FIG. 11 illustrates a spectrum chart of the vocal signal which has been enhanced to specific strength according to the second embodiment of the invention;

FIG. 12 illustrates a spectrum chart of the main signal superimposed on the enhanced vocal signal according to the second embodiment of the invention;

FIG. 13 illustrates spectrum chart of the high-fidelity signal according to the second embodiment of the invention.

### DETAILED DESCRIPTION OF PREFERRED EMBODIMENTS

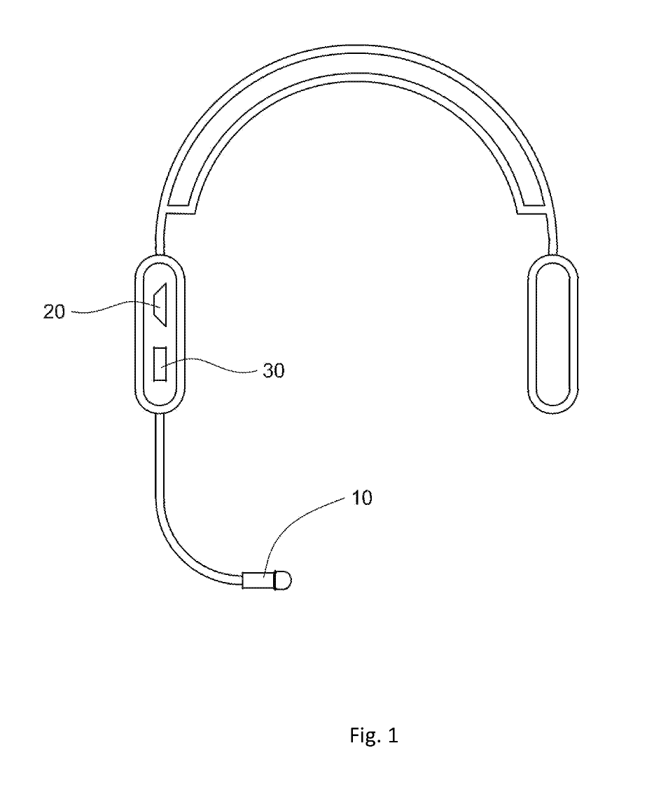

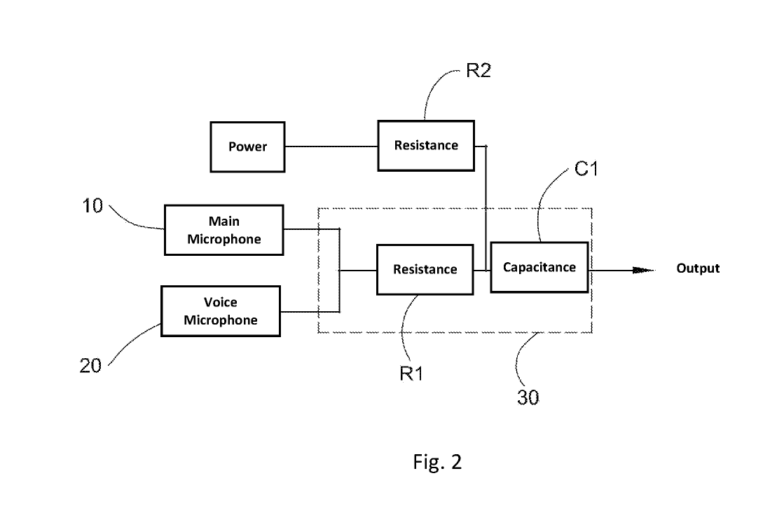

According to FIG. 1 and FIG. 2 for illustrating the first embodiment of this invention, the audio device uses a neckband earphone for explanatory purpose and may not be limited the scope of the present invention. The audio device includes a main microphone 10, a voice microphone 20 and a process circuit 30, wherein the process circuit 30 is separately connected to the main microphone 10 and the voice microphone 20.

The main microphone 10 perceives the user's sound and generates a main signal. In possible practice, the main microphone may be an non-directional microphone or a uni-directional Microphone.

For more accurately perceiving the characteristics of user's voice, the voice microphone 20 may be mounted near to the sound (vocal cord) by user's inner ear or on user's neck to conceive the sound vibration and to generate the voice signal. In possible practice, the voice microphone 20 may be but not limited to an uni-directional microphone which is pointed to predetermine direction for signal receiving so as to lowering the possibilities of ambient noise recording. However, the voice microphone may be various kinds of sound detectors or vibration perceivers.

The process circuit 30 includes a resistance R1 and a capacitance C1, wherein the resistance R1 is capable of weakening signal strength and the capacitance C1 is capable of reducing noise. As the main microphone 10 and the voice microphone 20 are in parallel connection to one end of the resistance R1 enabling the process circuit 30 to receive the main signal and the voice signal. In another possible practice, for example, when the main microphone 10 and the voice microphone 20 are at different voltage, it's necessary to convert the DC voltage to the AC voltage before to superimpose the parallel connection of the main microphone 10 and the voice microphone 20. On the other end of the resistance R1 is connected to the capacitance C1, a Resistance R2 and a power, wherein the power and the resistance R2 are in series connection and are connected to the resistance R1 by a node, and the node is deployed on the path between the resistance R1 and the capacitance C1. As the main microphone 10 and the voice microphone 20 are in series connection, the main signal and the voice signal converge to a superimposed signal then transmit to the resistance R1 for decaying, and be reduced down the noise by the resistance C1 turning to a high-fidelity signal. In the embodiment the high-fidelity signal is an analog signal.

Below working steps illustrates this embodiment:

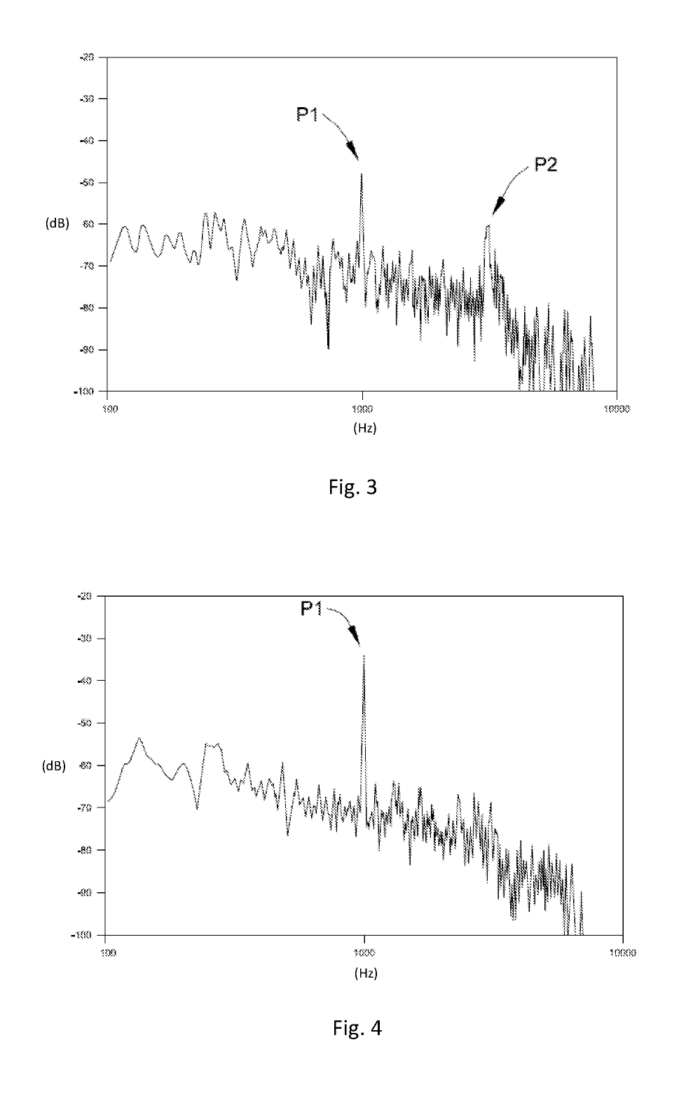

Firstly, the main microphone 10 which is adopted to receive the voice from user's mouth generates a main signal, wherein the audio signal P1 of real acoustic frequency and the noise signal P2 of ambient sound frequency reveal higher volume in decibels shown as spectrum chart in FIG. 3. At the same time, the voice microphone 20 which is employed to perceive the sound from user's inner ears or vocal cord generates a vocal signal, wherein the actual audio signal P1 of real acoustic frequency still has higher volume in decibels comparing to the other frequency range (including the frequency of noise signal P2) indicating that the vocal signal is barely influenced by the noise signal shown as spectrum chart in FIG. 4. In this embodiment, because the voice microphone 20 is mounted by the user's voice (vocal cord), the audio signal P1 perceived by the voice microphone 20 has relatively higher volume in decibels than the audio signal P1 received by the main microphone 10 even though the main microphone 10 and the voice microphone 20 can perceive audio signal P1 simultaneously.

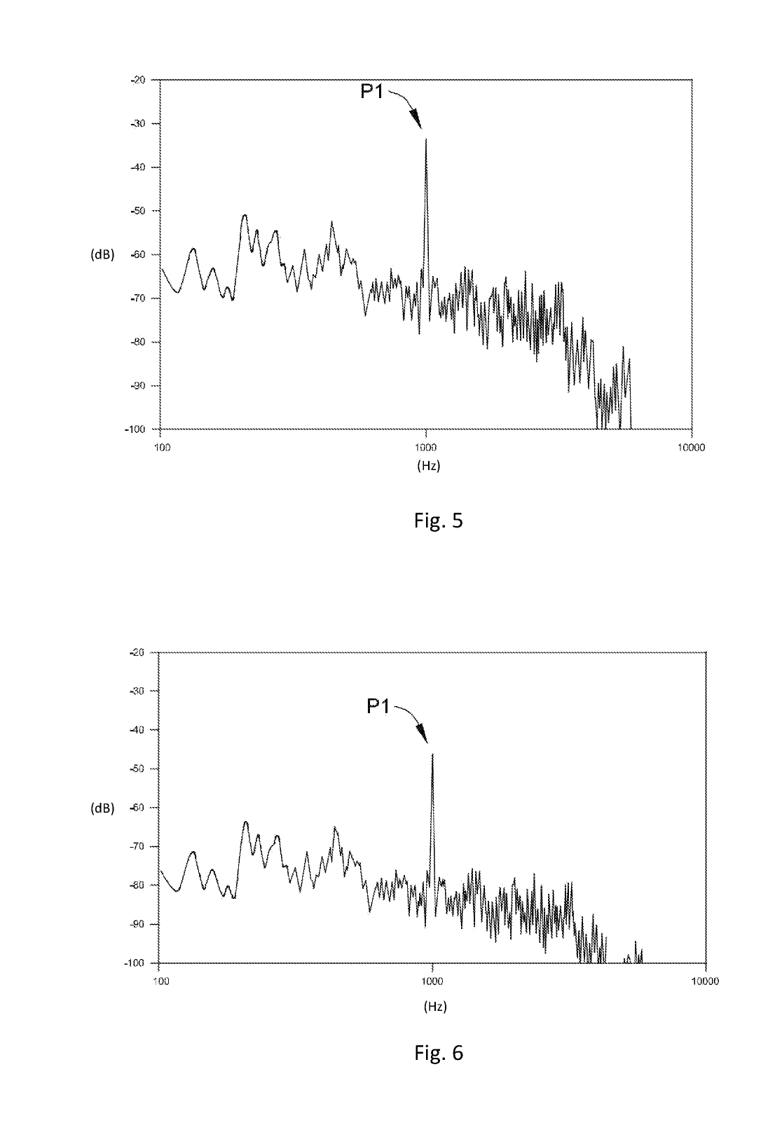

Then, because the main microphone 10 and the voice microphone 20 are in parallel connection, both of the signals converge to a superimposed signal shown as spectrum chart in FIG. 5. Said “converge” means the decibels of every frequency is added following below equation:

$$X dB + Y dB = 10 log ( {10}^{\frac{X}{10}} + {10}^{\frac{Y}{10}} ) dB$$

Wherein X represents the decibels of main signal, and Y represents the decibels of vocal signal. Because the main signal and the vocal signal already show higher volume in decibels comparing to the decibels of the other actual audio frequency in the beginning, they still perform higher in decibels after being superimposed, the audio signal P1 still reveal higher volume in decibels while the noise part raises less noticeable which difference grows bigger between the audio signal P1 and the noise signal.

Finally, superimposed signal is bound for decaying by way of reducing a predetermine strength in decibels, for example, the decibels value of every frequency is deducted equally by 10 decibels to gain a high-fidelity signal shown as the spectrum chart in FIG. 6. Through the exemplary signal process of this invention, the strength of audio signal P1 of real acoustic frequency and the strength of audio signal P1 of main signal are kept or even stronger while the strength of the rest noise signal is apparently lower, which makes the audio signal P1 stands out and the high-fidelity and low-distortion technology effect remain intact. Besides, the advantage of this embodiment needs no extra digital signal processor (DSP) to execute the process of signal superimposing and reducing, the hardware cost can be reduced and the power consumption can accordingly be lower therefore.

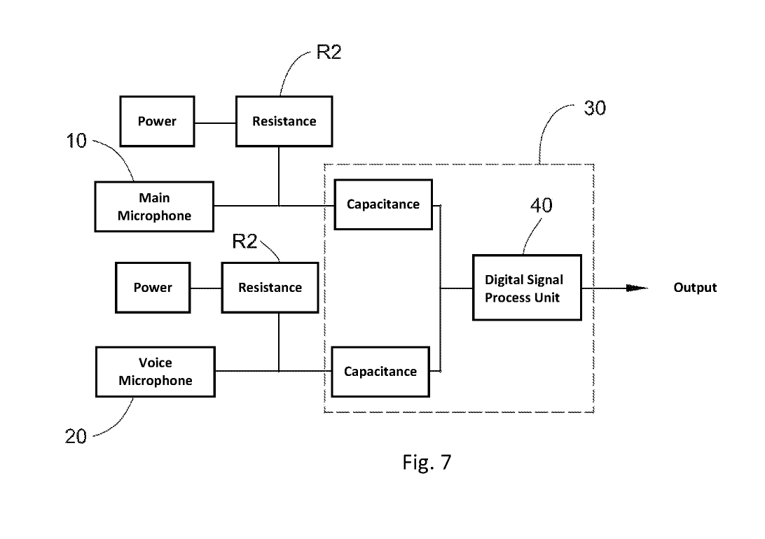

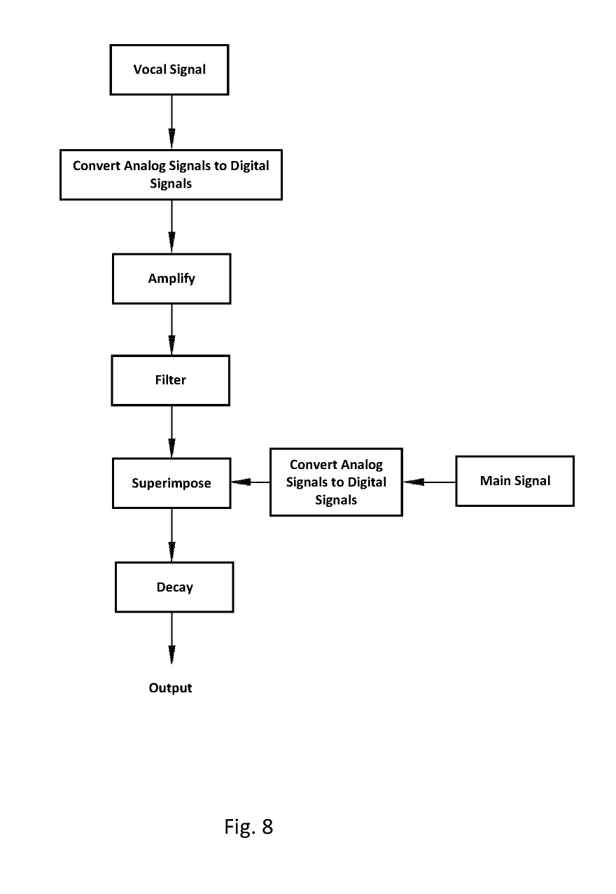

FIG. 7 and FIG. 8 illustrate the flow chart and the block diagram of the second embodiment which difference lies in the second embodiment having a digital signal process unit 40. The digital signal process unit 40 separately perceives the signals from the main signal of main microphone 10 and from the vocal signal of voice microphone 20 and said perceived signals may be reduced noise by the capacitance in advance. Then the digital signal process unit 40 converts the analog signals to digital signals, said digital signals orderly get amplified, wave filtered, superimposed with the converted main signal, and finally decaying the superimposed signal to generate a high-fidelity signal.

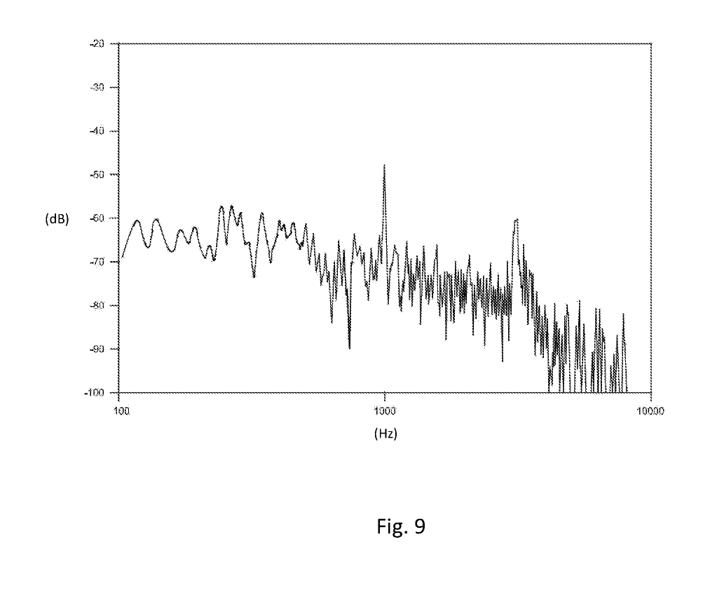

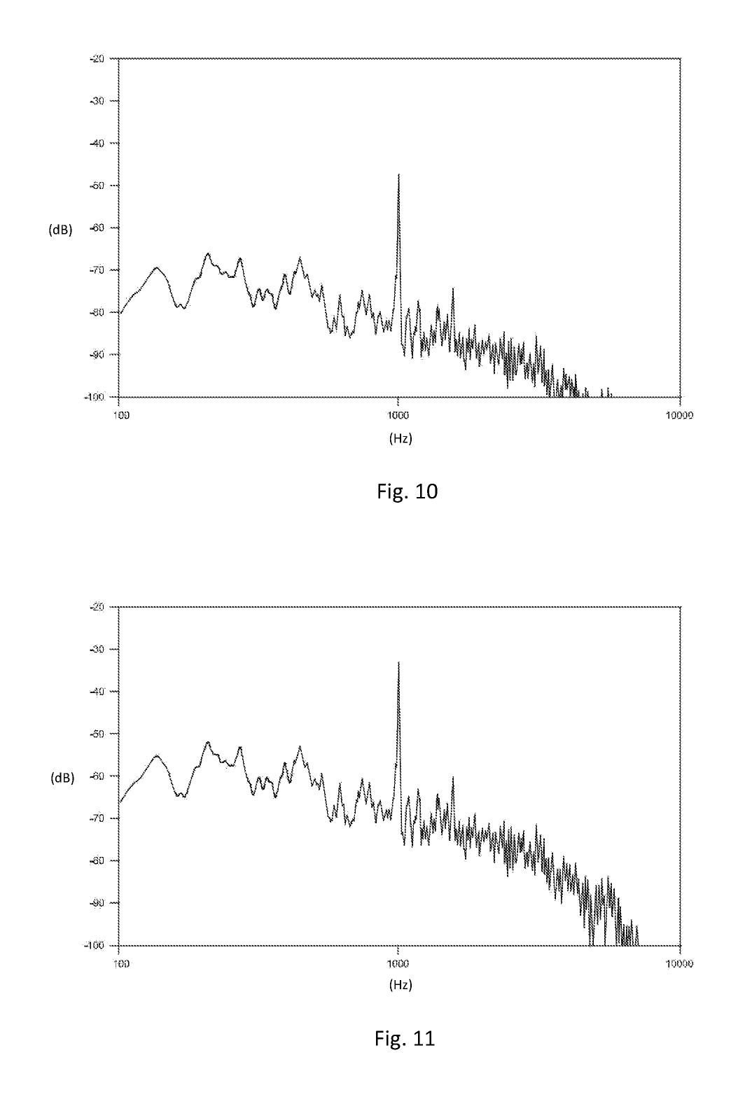

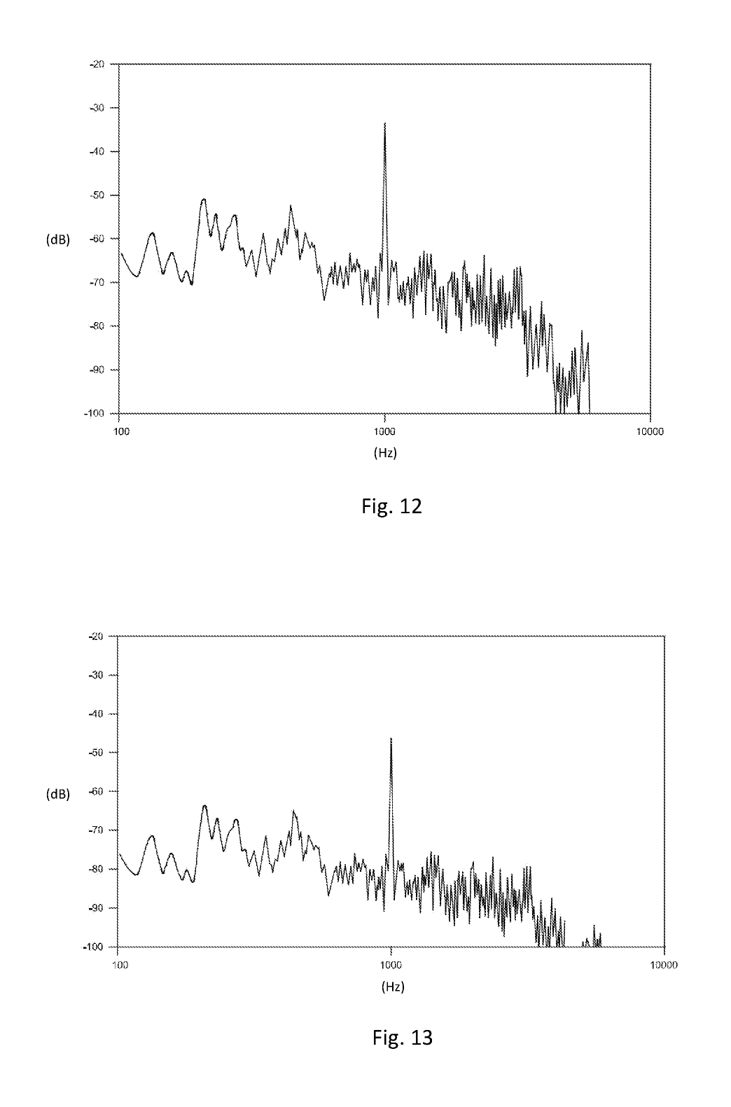

At working, the main microphone 10 generates the main signal shown as FIG. 9, and the voice microphone 20 produces the vocal signal shown as FIG. 10. At first, the analog signal of main signal and the analog signal of vocal signal are converted to a digital signal by the digital signal process unit, the vocal signal gets amplified overall by the digital signal process unit 40 shown as spectrum chart in FIG. 11, then the amplified vocal signal is superimposed with the main signal shown as spectrum chart in FIG. 12, and finally is decayed (overall deduces a predetermine strength) to a high-fidelity signal shown as spectrum chart in FIG. 13. Compared to the first embodiment, the second one amplifies all the vocal signal before superimposing process having the merit that the noise becomes less obvious and the audio signal gets standing out keeping high-definition and high-fidelity performance. On top of that, the digital signal process unit may provide extra audio process function as well.

1. A high-fidelity audio device comprising:
a main microphone for receiving sound and generating main signal;
a voice microphone for perceiving user's vocal vibration and producing a vocal signal; and
a process circuit for collecting the main signal and the vocal signal, and then superimposing the collected signals and decaying the collected signals to generate a high-fidelity signal.

2. The high-fidelity audio device according to claim 1, wherein the voice microphone is a directional microphone pointed to the user.

3. The high-fidelity audio device according to claim 1, wherein the voice microphone is a vibration detector.

4. The high-fidelity audio device according to claim 1, wherein the voice microphone is mounted by user's inner ear or on the neck.

5. The high-fidelity audio device according to claim 1, wherein the main signal and the vocal signal are in parallel connection to a process circuit.

6. The high-fidelity audio device according to claim 1, wherein the process circuit has at least a resistance that is capable of reducing the signal strength and decaying the superimposed main signal and the vocal signal.

7. The high-fidelity audio device according to claim 1, wherein the process circuit further includes a digital signal process unit for amplifying the strength of vocal signal, the amplified vocal signal being superimposed with main signal and then decayed to generate the high-fidelity signal.

8. The high-fidelity audio device according to claim 1, wherein the high-fidelity signal is an analog signal.

9. The high-fidelity audio device according to claim 1, wherein the strength of high-fidelity signal corresponding to the audio signal of real acoustic frequency is no less than the strength of audio signal of main signal corresponding to the audio signal of real acoustic frequency.

10. The high-fidelity audio device according to claim 1, wherein the main signal and the vocal signal are analog signal.

11. The high-fidelity audio device according to claim 1, wherein the main signal includes an audio signal corresponding to real acoustic frequency and a noise signal corresponding to ambient sound frequency, and the vocal signal includes an audio signal corresponding to real acoustic frequency, wherein the audio signal of vocal signal has apparently higher volume in decibels than the audio signal of main signal has.
